(19) United States
(12) Patent Application Publication
(10) Pub. No.: US 2007/0239833 A1
(43) Pub. Date: Oct. 11, 2007

(54) Device specific communication notifications

(75) Inventors: Jordan Alperin, Denver, CO (US); Rich Cerami, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO (US)

(21) Appl. No.: 11/400,644

(22) Filed: Apr. 6, 2006

(51) Int. Cl. G06F 15/16; G06F 15/173

(52) U.S. Cl. 709/206; 709/224

(57) ABSTRACT

Systems, methods, and machine-readable media are disclosed to provide device specific notification of incoming communications. In one embodiment, a method of providing device specific notification of incoming communications can comprise receiving a request to initiate a communication from an initiating end device. The request can identify an intended recipient device. A format for a notification to the recipient device can be determined based on user profile information for the recipient device. The notification to inform a user of the recipient device of the communication can be generated based on the format. The notification can then be sent to the recipient device.

### CROSS REFERENCE TO RELATED APPLICATIONS

This application is related to co-pending U.S. patent application Ser. No. 11/255,089 entitled “Cross-Platform Support for a Variety of Media Types” filed Oct. 19, 2005; co-pending U.S. patent application Ser. No. 11/266,011 entitled “Cross-Platform Message Notification” filed Nov. 2, 2005; and co-pending U.S. patent application Ser. No. 11/292,801 entitled “Cross Platform Redirection of Communications” filed on Dec. 2, 2005; all of which are herein incorporated by reference.

### BACKGROUND OF THE INVENTION

Embodiments of the present invention relate generally to communications networks and more particularly to providing notification of incoming communications in a form specific to the device by which the notification is presented.

Today, it is very common, and probably the norm, for an individual to have and regularly use a number of communications devices of different types that communicate via a variety of different media. For example, an individual may, on a daily basis, use a number of different telephones such as a work line, a home line, one or more cell phones, etc. Additionally, this same individual may have and use a number of other communications devices and/or media such as one or more email accounts, one or more instant message accounts, etc. that are accessible through any of a number of different devices such as personal computers, various portable devices, and/or other network attached devices that communicate via the Internet or other network.

An individual using a number of communication devices may not be in constant or even regular use of one or more of these devices. So, this individual may want to receive a notification on his Personal Digital Assistant (PDA) or personal computer (PC) when a call is being received by his cell phone. For example, an individual may not carry his cell phone or PDA with him at all times. However he may want to receive a notice via his PC of an incoming communication to one of those devices.

However, this leaves providers of communication services with the problem of determining what notices to send to which devices. Furthermore, the service providers needs to determine how to send those notices. That is, the service providers needs to determine what kind or format of message to send to the various devices through which a user may wish to receive notices of incoming communications. Hence, there is a need for methods and systems that allow for device specific notification of incoming communications.

### BRIEF SUMMARY OF THE INVENTION

Systems, methods, and machine-readable media are disclosed to provide device specific notification of incoming communications. In one embodiment, a method of providing device specific notification of incoming communications can comprise receiving a request to initiate a communication from an initiating end device. The request can identify an intended recipient device. A format for a notification to the recipient device can be determined based on user profile information for the recipient device. The notification to inform a user of the recipient device of the communication can be generated based on the format. Generating the notification can comprise generating code specific to a device type of the recipient device for causing the recipient device to present the notification to the user. The notification can then be sent to the recipient device.

According to one embodiment, the method can further comprise determining a plurality of options for handling the communication by the recipient device. This determination can be based on user profile information for the recipient device. In such a case, generating the notification can further comprise including the plurality of options for handling the communication in the notification. In such a case, determining a plurality of options for handling the communication can be based on a set of default options for a device type of the recipient device. Alternatively or additionally, the user profile information from the user of the recipient device can comprise one or more predetermined options defined by the user of the recipient device. In such a case determining a plurality of options for handling the communication can be, in part or in whole, based on the options defined by the user of the recipient device. In response to the user of the recipient device selecting an option from the plurality of options to accept the communication, connecting the initiating device with the recipient device.

According to another embodiment, the method can further comprise determining a plurality of possible recipient devices for the notification based on user profile information from the user of the recipient device. In such a case, the method can further comprise determining based on user profile information for each of the recipient devices a format for each of a plurality of notifications. Each notification can be provided to inform a user of each of the recipient devices of the communication. The method can also include generating the plurality of notifications based on the formats and sending the plurality of notifications to the plurality of possible recipient devices.

According to still another embodiment, a system for providing device specific notification of incoming communications can comprise a communications bus and a user profile database communicatively coupled with the communications bus and adapted to maintain user profile information. The system can also include a plurality of end devices of different types, each end device communicatively coupled with the communications bus and adapted to send and receive common language messages via the communications bus, to translate common language messages received from the communications bus to a format specific to the end device based on the type, and to store user profile information in the user profile database. One or more managers can be communicatively coupled with the communications bus. At least one manager can be adapted to receive via the communications bus a request to initiate a communication from an initiating device from the plurality of end devices. The request can identify an intended recipient device from the plurality of end devices. The manager can determine a format for a notification to the recipient device based on user profile information for the recipient device, generate the notification based on the format to inform a user of the recipient device of the communication, and send the notification to the recipient device.

According to another embodiment, the manager can be further adapted to determine a plurality of options for handling the communication by the recipient device. This determination can be based on user profile information for the recipient device. In such a case, generating the notification can further comprise including the plurality of options for handling the communication in the notification. In such a case, determining a plurality of options for handling the communication can be based on a set of default options for a device type of the recipient device. Alternatively or additionally, the user profile information from the user of the recipient device can comprise one or more predetermined options defined by the user of the recipient device. In such a case determining a plurality of options for handling the communication can be, in part or in whole, based on the options defined by the user of the recipient device. In response to the user of the recipient device selecting an option from the plurality of options to accept the communication, connecting the initiating device with the recipient device.

According to still another embodiment, the manager can be further adapted to determine a plurality of possible recipient devices for the notification based on user profile information from the user of the recipient device. In such a case, the manager can further determine based on user profile information for each of the recipient devices a format for each of a plurality of notifications. Each notification can be provided to inform a user of each of the recipient devices of the communication. The manager can also generate the plurality of notifications based on the formats and send the plurality of notifications to the plurality of possible recipient devices.

According to yet another embodiment, a machine-readable medium can have stored thereon a series of instruction which, when executed by a processor, cause the processor to providing device specific notification of incoming communications by receiving a request to initiate a communication from an initiating end device, the request identifying an intended recipient device. A format for a notification to the recipient device can be determined based on user profile information for the recipient device. The notification can be generated based on the format to inform a user of the recipient device of the communication. The notification can then be sent to the recipient device.

### BRIEF DESCRIPTION OF THE DRAWINGS

FIG. 1 is a block diagram illustrating, at a high-level, functional components of an architecture for providing device specific notifications of incoming communications according to one embodiment of the present invention.

FIG. 2 is a block diagram illustrating functional component of an architecture for providing device specific notifications of incoming communications according to an alternative embodiment of the present invention.

FIG. 3 is a block diagram illustrating an exemplary computer system in which embodiments of the present invention may be implemented.

FIG. 4 illustrates an exemplary user interface for informing a user of a communication according to one embodiment of the present invention.

FIG. 5 illustrates an exemplary user interface for informing a user of a communication according to an alternative embodiment of the present invention.

FIG. 6 is a flowchart illustrating a process for device specific notifications of incoming communications according to one embodiment of the present invention.

FIG. 7 is a flowchart illustrating additional details of a process for device specific notifications of incoming communications according to another embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Embodiments of the present invention relate to providing device specific notifications of incoming communications. According to one embodiment, providing device specific notification of incoming communications can comprise receiving a request to initiate a communication from an initiating end device. The request can identify an intended recipient device. A format for a notification to the recipient device can be determined based on user profile information for the recipient device. The notification to inform a user of the recipient device of the communication can be generated based on the format. Generating the notification can comprise generating code specific to a device type of the recipient device for causing the recipient device to present the notification to the user. The notification can then be sent to the recipient device.

That is, an initiating device, such as a cell phone, PC, etc. can send a request for communications, such as by placing a call, to a service provider. The service provider, or other system, can determine the type of device the communication is intended for and/or the type or format of message to send to that device. These determinations can be based on information related to the recipient device and stored in a user profile database or other repository. Based on this information, the service provider or other system can generate a message in the proper format, i.e., a format that is acceptable and useful to the recipient device, and send the message to the recipient device.

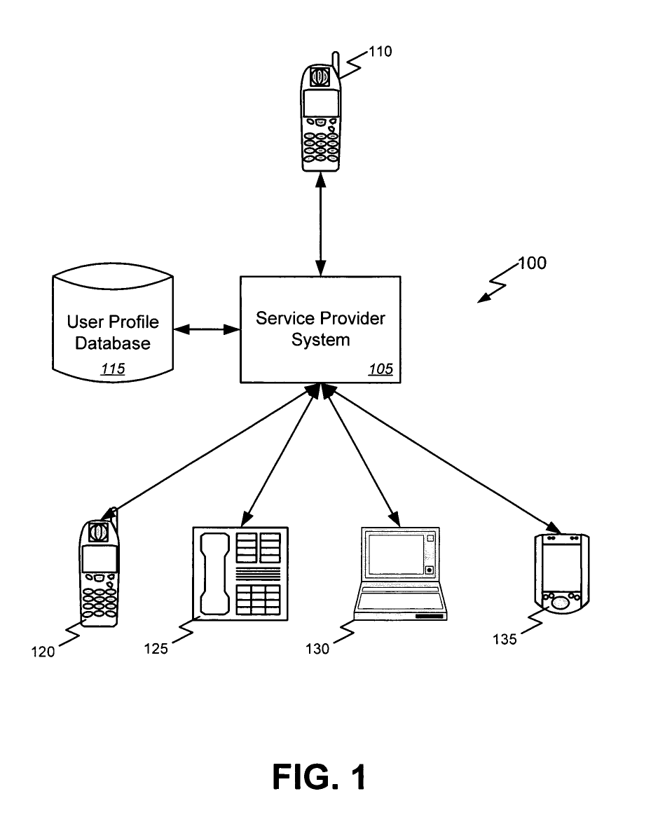

FIG. 1 is a block diagram illustrating, at a high-level, functional components of an architecture for providing device specific notifications of incoming communications according to one embodiment of the present invention. In this example, the system 100 includes an initiating device 110 communicatively coupled with a service provider system 105. The service provider system 105 can be communicatively coupled with a user profile database 115 and a plurality of recipient devices 120-135. Generally speaking, and as will be described in greater detail below, the initiating device 110 can initiate a communication such as a telephone call to one of the recipient devices 120-135 through the service provider system 105. Based on information stored in the user profile database 115 and as described, for example, in the co-pending U.S. patent application entitled “Cross-Platform Message Notification” referenced above, the service provider system 105 can notify one or more of the recipient devices 120-135 of the communication. Furthermore, the notification can include a number of options for handling the communication based on information stored in the user profile database 115 by the user of the initiating device 110, the user of the recipient device 120-135, and/or by default. Details of the information of the user profile database 115 will be discussed further below. Generally speaking the user profile database 115 can include default or standard options for handling communications and/or specific options for how the recipient and/or originator may be able to or wish to handle communications.

Initiating device 110 can be any of a number of possible communication devices. While illustrated here as resembling a cell phone, initiating device can also be a land line telephone, a Personal Digital Assistant (PDA), any of a variety of wireless devices, a personal computer, etc. Regardless of the exact type of device, initiating device 110 can be communicatively coupled with service provider system 105 via typical communication media such as a cellular network, a land line telephone, a Local Area Network (LAN), Wide Area Network (WAN), the Internet, or other type of network. Through this communication media, initiating device 110 can send and receive communications to and from the service provider system 105.

Service provider system 105 can be one or more systems adapted to provide communications services of one or more types to the initiating device 110. For example, service provider system 105 can be a system providing cellular telephone services, land line telephone services, Internet services, etc. Service provider system 105 can be adapted to send and receive communications of an appropriate type to and from initiating device 110.

User profile database 115 can be communicatively coupled with service provider system 105 via a Local Area Network (LAN), Wide Area Network (WAN), the Internet, or other type of network or other communications media. While user profile database 115 is shown in this example as being separate from the service provider system 105, the user profile database may be internal or external to the service provider system 105 or may be part of and/or maintained by another system and may be either local to or remote from the service provider system 105. Regardless of the exact configuration, user profile database 115 maintains a set of user profile data or preferences for one or more users of the service provider system 105 such as a user of initiating device 110 and/or users of recipient devices 120-135. For example, the user profile database 115 may include information relating to call features such as call forwarding or other information relating to other types of communications such as email delivery options. Additionally or alternatively, user profile database 115 may include information related to the types and numbers of devices used by the user and/or options for handling communications. Additionally or alternatively, some or all such information may also be stored in the initiating end device and accessed at the time the communication is initiated. As will be seen, such information can be used as or to provide device specific notifications of incoming communications.

According to one embodiment of the present invention, as described in the co-pending U.S. Patent Application entitled “Cross-Platform Message Notification” referenced above, user profile database 115 can also store information related to message notification features. More specifically, user profile database 115 can include a list of phone numbers, device addresses, or other identifying information for one or more recipient devices that a user of an initiating device may wish to contact. In other words, the user profile database 115 can include an identifier, such as a phone number, email address, Internet Protocol (IP) address, instant message address, physical address, MAC address, etc for each of the plurality of possible recipient devices. When the user of the initiating device 110 initiates a communication to one of these devices, the service provider system 105 can look up the recipient device, and possibly other related devices, and generate a message, communication, notification, etc. appropriate to each of those devices to inform the recipient of the requested communication.

User profile database 115 can also include, for example, a list of devices the recipient and/or the originator have available. In some cases, the user profile database 115 can additionally or alternatively include a list of standard options for handling and/or redirecting communications. For example, some standard or default options may include options to answer or receive the call or communications, ignore or disconnect the communications, send the originator a standard or other predetermined message, etc. Additional details of a method for generating and or sending such options will be discussed below.

Recipient devices 120-135 can be any of a number of possible communication devices. For example, recipient devices can be cell phones, land line telephones, Personal Digital Assistants (PDAs), any of a variety of wireless devices, Personal Computers (PCs), etc. Regardless of the exact types of devices, recipient devices 120-135 can be communicatively coupled with service provider system 105 via typical communication media such as a cellular network, a land line telephone, a Local Area Network (LAN), Wide Area Network (WAN), the Internet, and/or other types of networks. Through this communication media recipient devices 120-135 can send and receive communications to and from the service provider system 105.

Importantly, while referred to herein as a recipient device or an initiating device for the sake of explanation, any device coupled with the service provider system 105 can potentially, at various times, act as either an initiating device or a recipient device. For example, a particular cell phone may at one point initiate a call but at another time may receive a call. Therefore, the labels of initiating device and recipient device are illustrative only and indicate only a particular device's function at a specific point in time rather than indicating any limits on its functionality overall.

In use, initiating device 110 can initiate a communication, such as a phone call, email, instant message, etc. According to one embodiment of the present invention, this can be accomplished by the initiating device 110 sending a request to the service provider system 105. The request can identify a single intended recipient device. That is, the initiating device 110 can place a call to a particular phone number or send a message to a particular email or Internet Protocol (IP) address or otherwise direct a communication to a particular recipient device.

The service provider system 105 can then receive the request to initiate a communication from the initiating end device 110 and determine a format for a notification to the recipient devicel30. The proper format for the notification to the recipient device 130 can be determined based on user profile information for the recipient device 130 from the user profile database 115. That is, the user profile database 115 can include information indicating the type of device the recipient is, e.g., PC, telephone, email account, etc. and/or the types of messages, e.g., email, HTML, Java script or applet, audio file, etc., that can be read by that device. The notification to inform a user of the recipient device 130 of the communication can be generated based on the device type and/or format(s). Generating the notification can comprise, for example, generating code specific to a device type of the recipient device 130 for causing the recipient device 130 to present the notification to the user. For example, if the user profile database 115 indicates that a particular recipient device 130 can accept a Java applet, an appropriate applet can be read or generated that, when executed by the recipient device 130, causes the recipient device 130 to present a notification to the user through the recipient device's 130 user interface.

According to one embodiment, a plurality of options for handling the communication by the recipient device 130 can also be determined. This determination can be based on user profile-information for the recipient device 130. According to one embodiment, these options can be determined in accordance with the methods described in the above referenced application entitled “Cross Platform Redirection of Communications.” Furthermore, generating the notification can further comprise including the plurality of options for handling the communication in the notification. That is, the user profile database 115 may have associated with the recipient device 130 a number of options, such as “send to voicemail”, “answer”, “ignore”, etc., for handling an incoming communication. These options can be read from the user profile database 115 by the service provider system 105 and included in the notifications as appropriate under the format for that message. Then, for example, in response to the user of the recipient device 130 selecting one of the option from the plurality of options to accept the communication, the initiating device 110 can be connected with the recipient devicel30, can be sent to voicemail, can be disconnected, etc.

According to one embodiment, determining a plurality of options for handling the communication can be based on a set of default options for a device type of the recipient device 130. Alternatively or additionally, the user profile information from the user of the recipient device 130 can comprise one or more predetermined options defined by the user of the recipient device 130. In such a case determining a plurality of options for handling the communication can be, in part or in whole, based on the options defined by the user of the recipient device 130.

According to another embodiment, a plurality of possible recipient devices 120-135 for the notification can be determined based on user profile information from the user of the recipient device 130. This can be accomplished as described in the above references application entitled “Cross Platform Message Notification.” Restated briefly, one or more other recipient end devices 125 and 135 can be determined based on user profile information related to the intended recipient device 130. In such a case, the method can further comprise determining based on user profile information for each of the recipient devices 125-135 a format for each of a plurality of notifications. Each notification can be provided to inform a user of each of the recipient devices 125-135 of the communication. The method can also include generating the plurality of notifications based on the formats and sending the plurality of notifications to the plurality of possible recipient devices 125-135. That is, each of a plurality of recipient devices 125-135 can be sent a notification in a format that is appropriate to each individual device.

Alternatively, another architecture that provides support for communications between a number of different devices of different types may be used to provide the same functions. Such an architecture is described in the above referenced, co-pending U.S. patent application titled “Cross Platform Support for a Variety of Media Types.” While not necessary to implement various embodiments of the present invention, such an architecture is considered useful with embodiments of the present invention since it provides a communication bus that in turn provides a common representation, in the form of a number of common language messages, of services or information available to, from, and between end devices regardless of the type of end device or the server providing or receiving the information or service. For example, one of these common language messages can be used to provide notification of communications and options for handling the communication. Furthermore, the architecture includes a central user profile database that can be used to store information related to various end devices such as discussed above. An overview of this architecture is now provided for convenience.

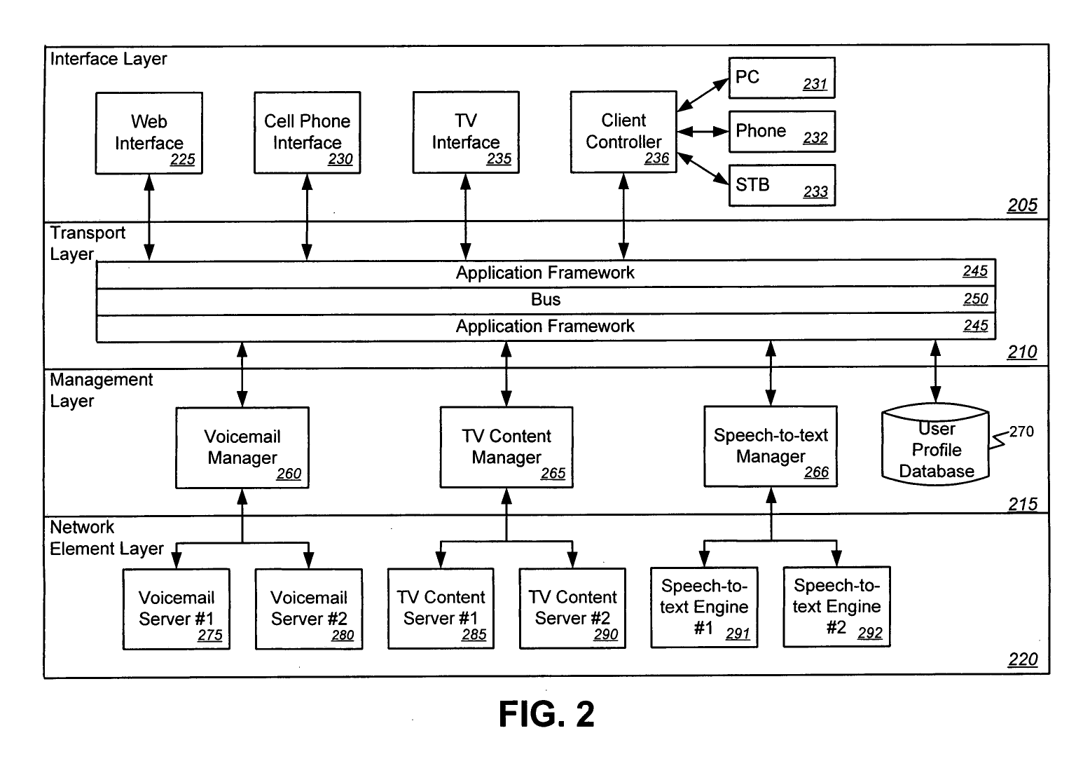

FIG. 2 is a block diagram illustrating functional component of an architecture for providing device specific notifications of incoming communications according to an alternative embodiment of the present invention. In this example, the architecture is logically divided into four layers 205-220. The layers 205-220 include a network element layer 220, a management layer 215, a transport layer 210, and an interface layer 205. As will be seen, elements of each layer 205-220 can be communicatively coupled with elements of the next layer 205-220. So, elements of the network element layer 220 can be communicatively coupled with elements of the management layer 215 which in turn can be communicatively coupled with elements of the transport layer 210, etc.

The network element layer 220 can comprise one or more servers 275-292. The servers 275-292 of the network element layer 220 can each provide content and/or services of one or more types. For example, one or more servers 275 and 280 may provide voicemail services while one or more other servers 285 and 290 provide television (TV) content services, while yet other servers 291 and 292 provide speech-to-text services, etc.. Importantly, while this example shows a limited number of servers 275-292 in the network element layer 220, many more servers, providing a wide range of content or services of various types may be included. For example, one or more servers may be included for providing Internet services, Email services, and various other types of data, communication, and/or entertainment services.

The management layer 215 can comprise one or more managers 260-266. Each manager 260-266 can be communicatively coupled with one or more of the servers 275-292 of the network element layer 220. For example, voicemail manager can be coupled with voicemail servers 275 and 280 while TV content manager 265 can be coupled with TV content servers 285 and 290. Importantly, while managers 260-266 and servers 275-292 are shown and described herein as being organized by or arranged per service, other arrangements are contemplated and considered to be within the scope of the present invention. According to one alternative, the managers 260-266 and the servers 275-292 may be arranged by company or provider. So, for example, one manager may be coupled with and provide access to the services and content provided by the servers of company A while another manager may be coupled with and provide access to the services and content provided by the servers of company B. However, an arrangement of managers 260-266 and servers 275-292 based on service and/or content type may be preferable since, as will be seen, such an arrangement can provide for easier extensibility of the system when adding features or services.

Furthermore, as noted above, additional servers may be used in the network element layer providing additional services and/or content of different types. Therefore, more, fewer, or different managers than shown in this example may be used in an actual implementation. For example an additional manager may be used for interfacing with one or more servers providing Internet services or email services. In another example, one or more managers may be communicatively coupled with one or more servers tracking billable events on the architecture. That is, one manager may track calls, messages, events, or pay-per-view or other content billed on a per-use basis so that the appropriate users can be billed by the operator of the architecture, the provider of the content, and/or other parties.

Regardless of the exact number, nature, or organization of the servers 275-292 and managers 260-266, the managers 260-266 can be adapted to translate content of the servers 275-292 with which the manager 260-266 is connected from the media types of the servers 275-292 to one or more common language messages. That is, the managers 260-266 can provide translation from a service specific format to a common or generic format. For example, voicemail server #1 275 and voicemail server #2 280 may be operated by different entities and offer different information in different formats that may be completely incompatible with each other. However, voicemail manager 260 provides for translating these different functions, formats, etc into a common language message that can be used by all other elements of the architecture.

According to one embodiment of the present invention, the managers 260-266 can provide defined interfaces to the servers 275-292 of the network element layer 220. By using calls, invocations, requests, or other signals or messages to the managers 260-266, the servers 275-292 can pass content or messages to the managers 260-266 for translation to a common language message for transmission to another element of the architecture. For example, voicemail manager 260 may provide an Application Program Interface (API) for use by any voicemail server 275 and 280 connected with the voicemail manager 260. Voicemail servers 275 and 280 can then use API calls to the voicemail manager 260 to initiate services, pass content or other information, and/or otherwise communicate with the voicemail server 260. According to one embodiment of the present invention, calls to the API or other interface may be closely analogous to the common language messages generated by the manager. For example, as will be described in detail below, the manager may generate an “InitiateCommunication” message to initiate a communication. The manager's API may also provide a “InitiateCommunication” or other similar call to the servers to which it is connected through which the servers can initiate a communication.

While use of an API or other defined interface between the managers 260-266 and the servers 275-292 is not required, it may be preferred since, by using an API or other type of defined interface, the managers 260-266 can be easily extended or modified as services and/or content of the servers are added or changed or as new servers are added. That is, the use of a defined interface such as an API allows greater extensibility since the only changes made at the manager would be to add or modify an appropriate “stub,” module, or routine to add a new server, service, or content type without a need to make wholesale changes or re-write the managers.

According to one embodiment of the present invention, the manager and the API or interface of the manager may be implemented using object-oriented programming techniques. In such a case, the manager API calls made by the servers can cause the stub or module of the manager interfacing with the server to instantiate an object of a particular class type, such as a “InitiateCommunication” object, with properties representing, among other possibilities, the content of data to be communicated, the intended recipient(s), etc. Such an object or common language message may be defined in a common format readable by other elements of the architecture. For example, the object may be defined in an eXtensible Markup Language (XML) file. The manager can then transmit this object or common language message to any or all of the other elements of the architecture via the transport layer 210.

The transport layer 210 can comprise a communications bus 250 communicatively coupled with each of the managers 260-266. The bus 250 can be adapted to receive and transport the one or more common language messages from the managers 260-266. The transport layer 210 can also comprise an optional application framework 245 interposed between the end devices 225-236 of the interface layer 205 and the communications bus 250 and between the managers 260-266 and the communications bus 250. Generally speaking, the application framework 245 provides for monitoring and tracking of the common language messages placed on the bus 250 of the transport layer 210.

Regardless of whether the application framework 245 is used, the bus 250 of the transport layer 210 comprises a common representation of data that is usable by all elements of the architecture. Furthermore, the bus 250 provides this message to any or all devices in the architecture as appropriate regardless of the type of device.

According to one embodiment of the present invention, the bus 250 may also be implemented using object-oriented programming techniques. In such a case, a manager placing or sending a common language message on the bus 250 can call or invoke an API or other interface of the bus 250 or otherwise cause the instantiation of an object of a particular class type, such as a “InitiateCommunication” object, with properties representing, among other possibilities, the content of data to be communicated, the intended recipient(s), etc. The bus can then make this object or common language message available to any or all of the other elements of the architecture.

The interface layer 205 of the architecture can comprise one or more end devices 225-236 of different types. For example, the end devices 225-236 can represent a cell phone 230, a web browser 225, a TV interface 235, etc all potentially operating on different platforms with different operating systems. Each end device 225-236 can be communicatively coupled with the bus 250 of the transport layer, either directly or via the application framework 245, and can be adapted to receive and translate the common language messages to a format specific to the end device based on its type.

Alternatively or additionally, one or more of the end devices may comprise a client controller 236 communicatively coupled with the bus 250 of the transport layer 210 and one or more other end devices 231-233 such as a personal computer 231, television Set-Top Box (STB) 233 for television service, telephone 232, or other type of device. If used, the client controller 236 can be adapted to receive common language messages from the bus 250, translate content from the common language messages to a format specific to the end device(s) 231-233 for which it is intended, and deliver the device specific message to the device or devices. In some cases, the client controller 236 may also be adapted to act as a firewall for end devices 231-233 communicating via the bus 250 of the transport layer 210.

Therefore, the end devices 225-236 can translate from the common language messages, such as an XML message, to device specific representations of the information in that message for presentation to user in whatever format that device uses. According to one embodiment, the translation functions of the end devices can also be implemented using object-oriented programming techniques. In such a case, the end devices receive the common language messages such as XML encoded representations of the objects on the bus 250 of the transport layer 210. Translation can therefore comprise instantiating on the end device an object of the class indicated by the message with the properties indicated by the message thereby translating the properties of the object on the bus to a presentation language of the device.

Thus far, the description of the architecture has focused on messages from the servers 275-292 to the end devices 225-236. However, the end devices 225-236 can also be adapted to generate one or more common language messages based on user input and send the one or more common language messages to one or more of the managers 260-265 via the bus 250. For example, a cell phone 230 or other end device 225-236 can generate a “InitiateCommunication” message to be sent to any or all of the managers 260-265 or even to another end device. Therefore, the managers 260-265 can be further adapted to receive the common language messages from the end devices 225-236 via the bus 250 and to translate the common language messages to content of the media type of the servers 275-292 with which the manager 260-266 is connected.

According to one embodiment of the present invention, the architecture can include a user profile database 270 communicatively coupled with the bus 250 of the transport layer. The user profile database 270 can be adapted to maintain records of a set of user preferences for one or more of the end devices 225-236 of the interface layer 205. For example, TV or cell phone settings or options for a particular device and/or a particular user can be stored in the user profile database 270 for retrieval by one or more of the end devices 225-236 or one or more of the managers 260-266. Therefore, the user profile database 270 can be adapted to provide the preferences to one or more of the end devices 225-236 or one or more of the managers 260-266 in response to a common language message received via the bus 250. In another example, the user profile database 270 can be adapted to store information related to options for handling and/or redirecting communications. More specifically, user profile database 270 can include a list of standard or default options for handling a communication such as, for example, ignore or disconnect, accept, etc. Additionally or alternatively, the user profile database 270 can include a list of custom and/or user defined options such as one or more predefined recordings or stored voice, text, or other format responses or messages. In other cases, information can additionally or alternatively be stored in the user profile database 260 that can be used by one or more managers to generate options. For example, the user profile database 270 can include information identifying devices and/or types of devices available to the recipient and/or the data types and/or formats acceptable to those devices.

Therefore, in use, the bus 250 provides a common representation of services or information available to, from, and between the end devices 225-236 regardless of the type of end device or the server providing or receiving the information or service. This common representation is in the form of a number of common language messages. The type, number, format, etc. of the common language messages can vary widely depending upon the exact implementation without departing from the scope of the present invention. However, for illustrative purposes only, some exemplary messages will be described.

According to one embodiment, the common language messages can include a “InitiateCommunication” request message indicating a request to initiate a communication. Similarly, the common language messages can include a “InitiateCommunication” response message acknowledging initiation of a communication. As will be discussed in greater detail below, “InitiateCommunication” request and response messages can be used to provide notification of a communication and options for handling the communication as well as responding with a selection or request to redirect the communication. Alternatively or additionally, a separate communication notification message can be used to provide notification of a communication and options for handling the communication as well as responding with a selection or request to redirect the communication. According to another embodiment, the common language messages can include a “Communication Information” request indicating a request for information relating to a communication and a “Communication Information” response providing requested information. The common language messages can also include a “Communication Event Notification” message indicating the occurrence of a communication.

The various types of message can take any of a variety of possible formats without departing from the scope of the present invention. However, for illustrative purposes only, an exemplary format for a message may be considered to include a header and a body. The header may include information such as any or all of: an address or other indication of the device or devices for which the message is intended; an address or other indication of the device originating the message; an indication of the message type; an indications of the type of contents in the message; etc. The message body may include information such as representation of or actual content to be transferred. Therefore, the body can contain an email message, an audio or video file, a hyperlink or other direction to a location of the actual content, etc. However, once again, the exact format of the common language messages can vary widely depending on the exact implementation.

Regardless of the exact format, translating content to a common language message or generating a common language message can comprise generating a file, such as an XML file, of the appropriate format to indicate the type of message and the end devices for which it is intended and possibly an indication of the contents. Alternatively, as indicated above, various components of the architecture may be implemented using object-oriented programming techniques. In such a case, generating a common language message can comprise instantiating an object of a particular class type, such as a “InitiateCommunication” object, with properties representing, among other possibilities, the content of data to be communicated, the intended recipient(s), etc.

According to one embodiment, the common language messages can include a “InitiateCommunication” request message indicating a request to initiate a communication. Such a message can be initiated by one of the end devices 225-240 and sent via the bus 250 of the transport layer 210 to a manager 260 or 265 coupled with a server 275-292 providing a service to that end device. Upon receiving the message, the server or manager can, in some cases, look up the recipient device and possibly other devices related to the recipient device in the user profile database 270. The server can then generate “InitiateCommunication” request messages to the other devices to inform the recipient of the requested communication. According to one embodiment and as introduced above, the body of this message can include information in a format acceptable or compatible with the end device and may include a number of options for handling the communication.

So, the manager 265 or server 285 can receive the request to initiate a communication from the initiating end device 230 and determine a format for a notification to the recipient device 235. The proper format for the notification to the recipient device 235 can be determined based on user profile information for the recipient device 235 from the user profile database 270. That is, the user profile database 270 can include information indicating the type of device the recipient is, e.g., PC, telephone, email account, etc. and/or the types of messages, e.g., email, HTML, Java script or applet, audio file, etc., that can be read by that device. The notification to inform a user of the recipient device 235 of the communication can be generated based on the device type and/or format(s). Generating the notification can comprise, for example, generating code specific to a device type of the recipient device 235 for causing the recipient device 235 to present the notification to the user. For example, if the user profile database 270 indicates that a particular recipient device 235 can accept a Java applet, an appropriate applet can be read or generated that, when executed by the recipient device 235, causes the recipient device 235 to present a notification to the user through the recipient device's 235 user interface.

According to one embodiment, a plurality of options for handling the communication by the recipient device 235 can also be determined. This determination can be based on user profile information for the recipient device 235. According to one embodiment, these options can be determined in accordance with the methods described in the above referenced application entitled “Cross Platform Redirection of Communications.” Furthermore, generating the notification can further comprise including the plurality of options for handling the communication in the notification. That is, the user profile database 270 may have associated with the recipient device 235 a number of options, such as “send to voicemail”, “answer”, “ignore”, etc., for handling an incoming communication. These options can be read from the user profile database 270 by the manager 265 and included in the notifications as appropriate under the format for that message. Then, for example, in response to the user of the recipient device 235 selecting one of the option from the plurality of options to accept the communication, the initiating device 230 can be connected with the recipient device235, can be sent to voicemail, can be disconnected, etc.

According to one embodiment, determining a plurality of options for handling the communication can be based on a set of default options for a device type of the recipient device 235. Alternatively or additionally, the user profile information from the user of the recipient device 235 can comprise one or more predetermined options defined by the user of the recipient device 235. In such a case determining a plurality of options for handling the communication can be, in part or in whole, based on the options defined by the user of the recipient device 235.

According to another embodiment, a plurality of possible recipient devices 231-236 for the notification can be determined based on user profile information from the user of the recipient device 235. This can be accomplished as described in the above references application entitled “Cross Platform Message Notification.” Restated briefly, one or more other recipient end devices 231 and 232 can be determined based on user profile information related to the intended recipient device 235. In such a case, the method can further comprise determining based on user profile information for each of the recipient devices 231-236 a format for each of a plurality of notifications. Each notification can be provided to inform a user of each of the recipient devices 231-236 of the communication. The method can also include generating the plurality of notifications based on the formats and sending the plurality of notifications to the plurality of possible recipient devices 231 -236. That is, each of a plurality of recipient devices 231-236 can be sent a notification in a format that is appropriate to each individual device.

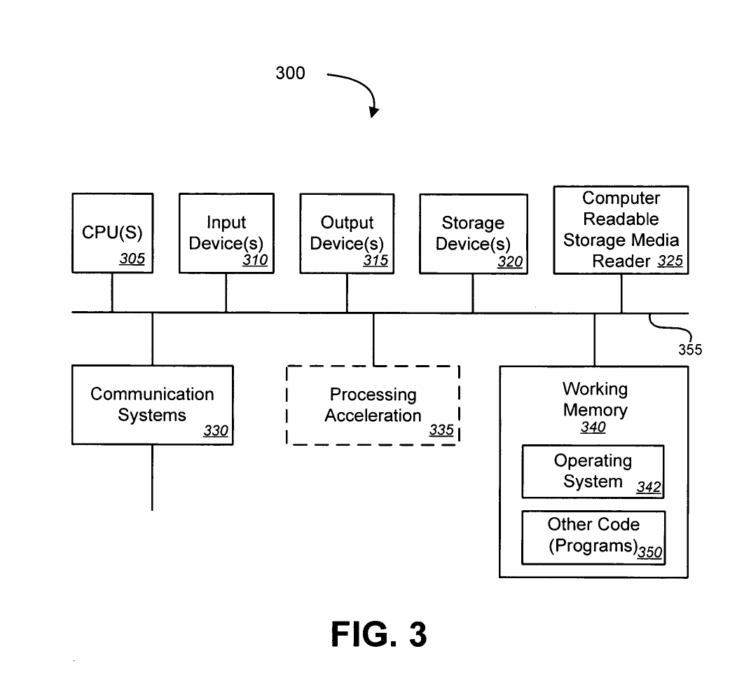

FIG. 3 is a block diagram illustrating an exemplary computer system in which embodiments of the present invention may be implemented. This example illustrates a computer system 300 such as may be used, in whole, in part, or with various modifications, to provide various components of the systems discussed above.

The computer system 300 is shown comprising hardware elements that may be electrically coupled via a bus 355. The hardware elements may include one or more central processing units (CPUs) 305, one or more input devices 310 (e.g., a mouse, a keyboard, etc.), and one or more output devices 315 (e.g., a display device, a printer, etc.). The computer system 300 may also include one or more storage device 320. By way of example, storage device(s) 320 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 325, a communications system 330 (e.g., a modem, a network card (wireless or wired), an infra-red communication device, etc.), and working memory 340, which may include RAM and ROM devices as described above. In some embodiments, the computer system 300 may also include a processing acceleration unit 335 , which can include a DSP, a special-purpose processor and/or the like.

The computer-readable storage media reader 325 can further be connected to a computer-readable storage medium, together (and, optionally, in combination with storage device(s) 320) comprehensively representing remote, local, fixed, and/or removable storage devices plus storage media for temporarily and/or more permanently containing computer-readable information. The communications system 330 may permit data to be exchanged with the network 320 and/or any other computer described above with respect to the system 300.

The computer system 300 may also comprise software elements, shown as being currently located within a working memory 340, including an operating system 445 and/or other code 350. It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

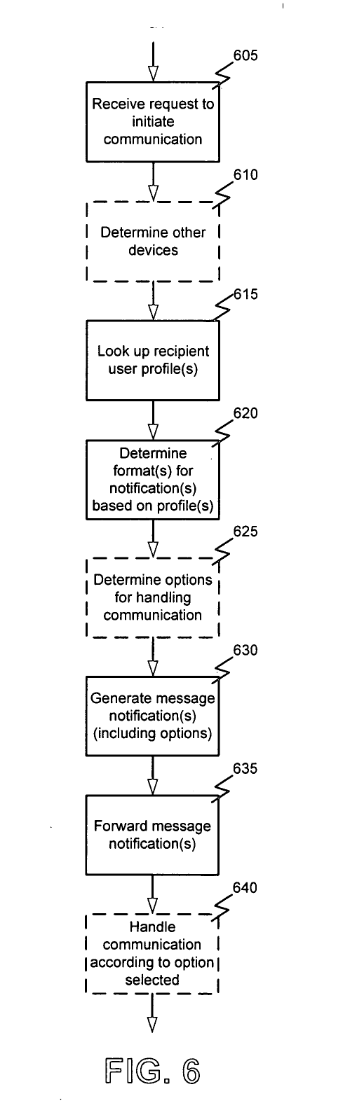

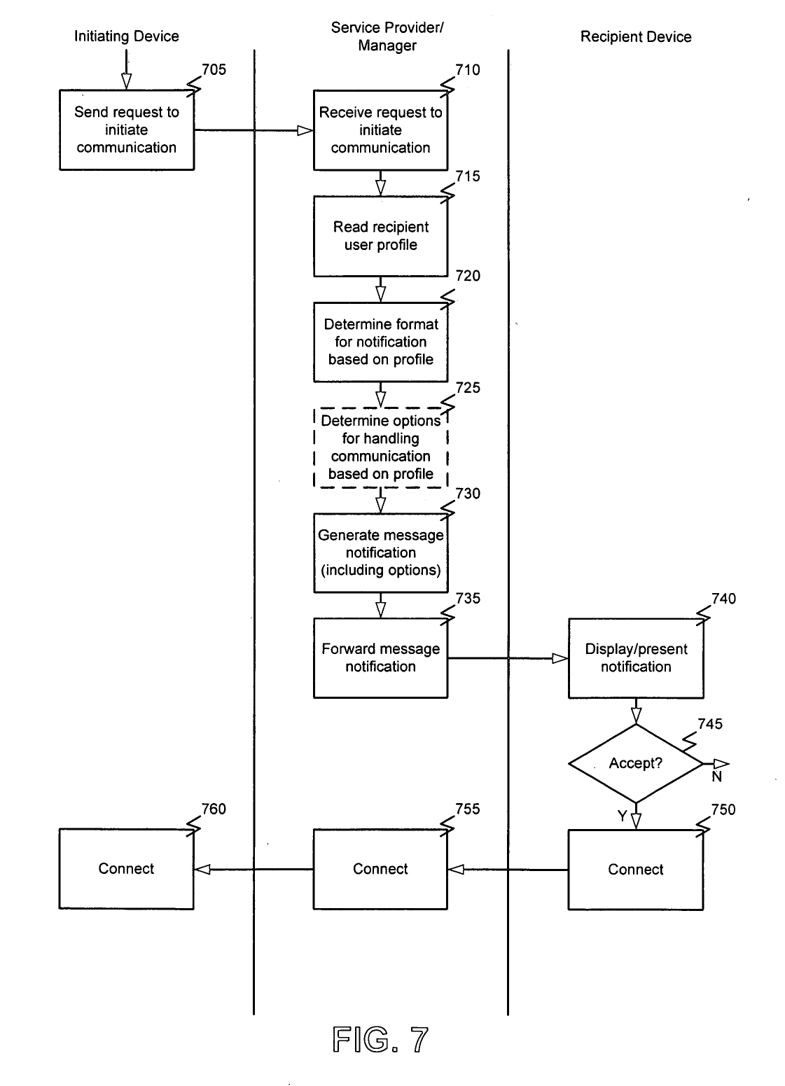

Software of computer system 300 may include code 350 for implementing any or all of the function of the various elements of the architectures as described herein. For example, software, stored on and/or executed by a computer system such as system 300, can provide the functions of the service provider system, a manager, an end device, etc. Methods implemented by software on some of these components will be discussed in detail below with reference to FIGS. 6 and 7.

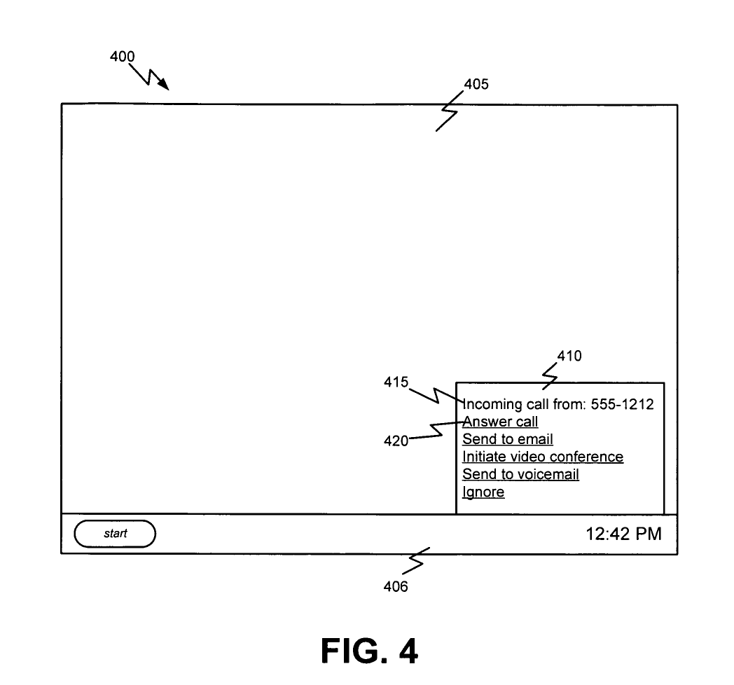

FIG. 4 illustrates an exemplary user interface for informing a user of a communication and presenting options for handling the communication according to one embodiment of the present invention. In this example, a user interface 400 is shown such as may be displayed by a web browser, other personal computer application, or similar display. The interface includes a typical display area 405 and a task bar 410 as is common in many operating systems. According to one embodiment of the present invention, when a notification is received that a communication is pending, such as receiving a phone call or other communication, a notification can be displayed on the interface 400. In this example, the notification is in the form of a pop-up 410 displayed in the display area 405 of the interface above the taskbar 410. In other cases, the notification can take other forms. For example, the notification may be presented as a ticker, a new application window, an icon on the display area 405 or taskbar 406, or any other type of audio and/or visual indication to the user.

Regardless of exactly how the notification is displayed, it can, according to one embodiment of the present invention, include an indication 415 that a communication is being received. In this example, the indication 415 is in the form of a line of text in the pop-up 410 indicating “Incoming call” and a number for the originator of the communication. In other cases, the indication may indicate another type of communication and/or include a name, photograph, etc. of the originator, and/or other information. Additionally, a list of options 420 for handling the communication can be included in the pop-up 410 or other notification. In this example, the list includes a number of hyperlinks that can be clicked by the user to select an option indicated by the text of the link. For example, the link indicating “Answer call” can be clicked by the user to accept the communication. As indicated above, the options presented in this list of options for handling the communication can be based on the user profile information for the originator of the communication, the recipient of the communication, or some combination thereof.

It should be understood that the format, appearance, content, etc. of the user interface can vary widely without departing from the scope of the present invention. For example, the interface can and likely would vary depending upon the device upon which it is presented. For example, a PC interface will look different from the interface presented by a cell phone, TV, PDA, pager, etc. Furthermore, the way in which notification is given and options presented can vary significantly without departing from the scope of the present invention. For example, rather than a list of links as shown in FIG. 4, options may be presented as clickable buttons or icons, a series of verbal instructions such as “To answer the call press FI”, or any other type of audio, visual, tactile or other sensory indication.

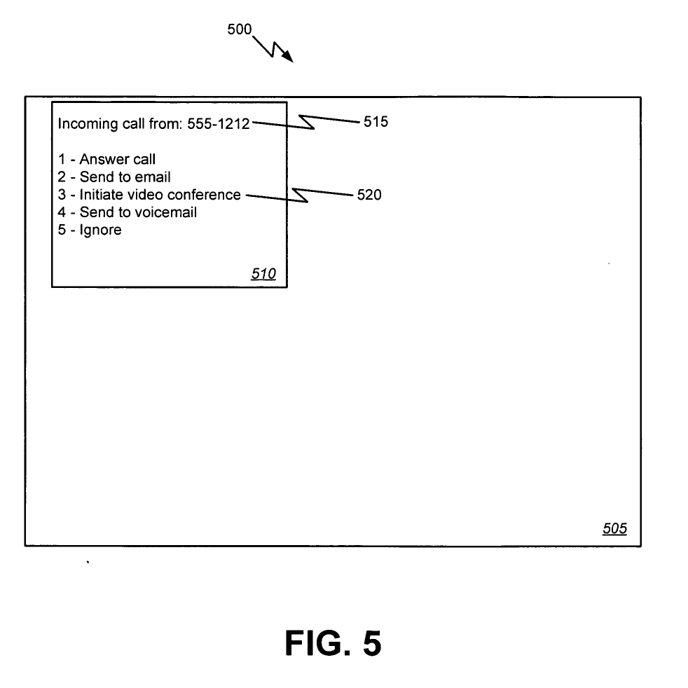

FIG. 5 illustrates an exemplary user interface for informing a user of a communication and presenting options for handling the communication according to an alternative embodiment of the present invention. In this example, a user interface 500 is shown that includes a display 505 such as may be found on a variety of different devices such as an TV, cell phone, etc. The display 505 includes a box 510 for displaying a notification displayed in the display area 505 of the interface. For example, this can represent a pop-up or drop down message box displayed on a television picture or a screen on a cell phone.

As with the previous example, the notification can, according to one embodiment of the present invention, include an indication 515 that a communication is being received. In this example, the indication 515 is in the form of a line of text indicating “Incoming call” and a number for the originator of the communication. In other cases, the indication may indicate another type of communication and/or include a name, photograph, etc. of the originator, and/or other information. Additionally, a list of options 520 for handling the communication can be included in the displayed notification. In this example, the list 520 includes a number of options that can be selected by the user pressing the corresponding number on a remote control, keyboard, or keypad. For example, the option indicating “Ignore” can be selected by the user pressing the number 5 on an input device.

The exact manner in which the user selects an option as well as the format and/or content of the notification can vary depending upon the type of device on which the notification is displayed and/or the type of input device used. For example, if displayed on a cell phone display or television screen, an option can be selected through the keypad of the phone or remote control of the television by pressing the corresponding number. In other cases, the keypad may provide some cursor controls, such as arrow keys, to allow the user to navigate through the options. In such a case, the notification can have a different format suitable for use with that device.

As indicated above, the options presented in this list of options for handling the communication, as well as the format, can be based on the user profile information for, among other things, the recipient of the communication. For example, if the user profile information of the user indicates that the recipient device is a PC, a notification such as described above with reference to FIG. 4 can be generated and sent. In another case, if the user profile database indicates that the recipient device is a television Set-Top Box of a particular type, a notification appropriate for that type of device can be generated and sent.

FIG. 6 is a flowchart illustrating a process for device specific notifications of incoming communications according to one embodiment of the present invention. This example represents a process that may be performed by the service provider system discussed above with reference to FIG. 1, one or more of the servers or managers of the management or network element layers discussed above with reference to FIG. 2, or another system or device depending upon the environment in which the methods are implemented.

In this example, the implementing system can receive 605 a request to initiate a communication from an initiating end device. The request can identify an intended recipient device. Receiving a request to initiate a communication can comprises receiving a phone call to a single phone number, receiving a message to a single address such as an email message or an Instant Message (IM), etc. Based on this request, the system can optionally determine 610 a plurality of possible recipient devices for the notification based on user profile information from the user of the recipient device.

Once the recipient or plurality of recipients has been determined, the user profile information can be read 615 for each of the recipient devices. From the user profile information, a format can be determined 620 for each notification to each recipient device based on user profile information for that recipient device.

Optionally, a plurality of options for handling the communication by the recipient device can be determined 625. This determination 625 can be based on user profile information for each of the recipient devices. According to one embodiment, determining 625 a plurality of options for handling the communication can be based on a set of default options for a device type of the recipient device. Alternatively or additionally, the user profile information from the user of the recipient device can comprise one or more predetermined options defined by the user of the recipient device. In such a case determining 625 a plurality of options for handling the communication can be, in part or in whole, based on the options defined by the user of the recipient device.

The notifications, including any options, can be generated 630 based on the format to inform a user of the recipient device of the communication. The notifications can be sent 635 to each of the recipient devices. Optionally, in response to the user of the recipient device selecting an option from the plurality of options to accept the communication, the initiating device can be connected with the recipient device or the communication an be otherwise handled 640.

FIG. 7 is a flowchart illustrating additional details of a process for device specific notifications of incoming communications according to another embodiment of the present invention. This example represents a process that may be performed by the service provider system discussed above with reference to FIG. 1, one or more of the servers or managers of the network element layer discussed above with reference to FIG. 2, or another system or device depending upon the environment in which the methods are implemented and illustrates the processes performed by the initiating device as well as the recipient device.

In this example, the initiating device sends 705 a request to initiate a communication to the service provider system or server as described above. The implementing system, such as a service provider system or manager, can receive 710 a request to initiate a communication from an initiating end device. The request can identify an intended recipient device. Receiving a request to initiate a communication can comprises receiving a phone call to a single phone number, receiving a message to a single address such as an email message or an Instant Message (IM), etc.

Once the recipient or plurality of recipients has been determined, the user profile information can be read 715 for each of the recipient devices. From the user profile information, a format can be determined 720 for each notification to each recipient device based on user profile information for that recipient device.

Optionally, a plurality of options for handling the communication by the recipient device can be determined 725. This determination 725 can be based on user profile information for each of the recipient devices. According to one embodiment, determining 725 a plurality of options for handling the communication can be based on a set of default options for a device type of the recipient device. Alternatively or additionally, the user profile information from the user of the recipient device can comprise one or more predetermined options defined by the user of the recipient device. In such a case determining 725 a plurality of options for handling the communication can be, in part or in whole, based on the options defined by the user of the recipient device.

The notifications, including any options, can be generated 730 based on the format to inform a user of the recipient device of the communication. The notifications can be sent 735 to each of the recipient devices. The recipient devices can display 740 or otherwise present the notification to the user. In response to the user of the recipient device selecting an option from the plurality of options to accept 745 the communication, the initiating device can be connected 750-760 with the recipient device or the communication an be otherwise handled.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of providing device specific notification of incoming communications, the method comprising:
receiving a request to initiate a communication from an initiating end device, the request identifying an intended recipient device;
determining a format for a notification to the recipient device based on user profile information for the recipient device;
generating the notification based on the format to inform a user of the recipient device of the communication; and
sending the notification to the recipient device.

2. The method of claim 1, further comprising determining a plurality of options for handling the communication by the recipient device based on user profile information for the recipient device.

3. The method of claim 2, wherein generating the notification further comprises including the plurality of options for handling the communication in the notification.

4. The method of claim 1, further comprising determining a plurality of possible recipient devices for the notification based on user profile information from the user of the recipient device.

5. The method of claim 4, further comprising:
determining based on user profile information for each of the recipient devices a format for each of a plurality of notifications, each notification to inform a user of each of the recipient devices of the communication; and
generating the plurality of notifications based on the formats.

6. The method of claim 5, further comprising sending the plurality of notifications to the plurality of possible recipient devices.

7. The method of claim 2, wherein determining a plurality of options for handling the communication is further based on a set of default options for a device type of the recipient device.

8. The method of claim 2, wherein the user profile information from the user of the recipient device comprises one or more predetermined options defined by the user of the recipient device and wherein determining a plurality of options for handling the communication is further based on the options defined by the user of the recipient device.

9. The method of claim 1, wherein generating the notification comprises generating code specific to a device type of the recipient device, the code for causing the recipient device to present the notification to the user.

10. The method of claim 1, further comprising in response to the user of the recipient device selecting an option from the plurality of options to accept the communication, connecting the initiating device with the recipient device.

11. A system for providing device specific notification of incoming communications, the system comprising:
a communications bus;
a user profile database communicatively coupled with the communications bus and adapted to maintain user profile information;
a plurality of end devices of different types, each end device communicatively coupled with the communications bus and adapted to send and receive common language messages via the communications bus, to translate common language messages received from the communications bus to a format specific to the end device based on the type, and to store user profile information in the user profile database; and
one or more managers, each manager communicatively coupled with the communications bus, wherein at least one manager is adapted to receive via the communications bus a request to initiate a communication from an initiating device from the plurality of end devices, the request identifying an intended recipient device from the plurality of end devices, to determine a format for a notification to the recipient device based on user profile information for the recipient device, to generate the notification based on the format to inform a user of the recipient device of the communication, and to send the notification to the recipient device.

12. The system of claim 11, wherein the at least one manager is further adapted to determine a plurality of options for handling the communication by the recipient device based on user profile information for the recipient device

13. The system of claim 12, wherein the at least one manager is further adapted to include the plurality of options for handling the communication in the notification.

14. The system of claim 11, wherein the at least one manager is further adapted to determine a plurality of possible recipient devices for the notification based on user profile information from the user of the recipient device.

15. The system of claim 14, wherein the at least one manager is further adapted to:
determine based on user profile information for each of the recipient devices a format for each of a plurality of notifications, each notification to inform a user of each of the recipient devices of the communication; and
generate the plurality of notifications based on the formats.

16. The system of claim 15, wherein the at least one manager is further adapted to send the plurality of notifications to the plurality of possible recipient devices.

17. The system of claim 12, wherein the at least one manager determines a plurality of options for handling the communication based on a set of default options for a device type of the recipient device.

18. The system of claim 12, wherein the user profile information from the user of the recipient device comprises one or more predetermined options defined by the user of the recipient device and wherein the at least one manager determines a plurality of options for handling the communication based on the options defined by the user of the recipient device.

19. The system of claim 11, wherein generating the notification comprises generating code specific to a device type of the recipient device, the code for causing the recipient device to present the notification to the user.

20. The system of claim 11, wherein the at least one manager is further adapted to connect the initiating device with the recipient device in response to the user of the recipient device selecting an option from the plurality of options to accept the communication.

21. A machine-readable medium having stored thereon a series of instructions that, when executed by a processor, cause the processor to provide device specific notification of incoming communications by:
receiving a request to initiate a communication from an initiating end device, the request identifying an intended recipient device;
determining a format for a notification to the recipient device based on user profile information for the recipient device;
generating the notification based on the format to inform a user of the recipient device of the communication; and
sending the notification to the recipient device.

22. The machine-readable medium of claim 21, further comprising determining a plurality of options for handling the communication by the recipient device based on user profile information for the recipient device

23. The machine-readable medium of claim 22, wherein generating the notification further comprises including the plurality of options for handling the communication in the notification.

24. The machine-readable medium of claim 21, further comprising determining a plurality of possible recipient devices for the notification based on user profile information from the user of the recipient device.

25. The machine-readable medium of claim 24, further comprising:
determining based on user profile information for each of the recipient devices a format for each of a plurality of notifications, each notification to inform a user of each of the recipient devices of the communication; and
generating the plurality of notifications based on the formats.

26. The machine-readable medium of claim 25, further comprising sending the plurality of notifications to the plurality of possible recipient devices.

27. The machine-readable medium of claim 22, wherein determining a plurality of options for handling the communication is further based on a set of default options for a device type of the recipient device.

28. The machine-readable medium of claim 22, wherein the user profile information from the user of the recipient device comprises one or more predetermined options defined by the user of the recipient device and wherein determining a plurality of options for handling the communication is further based on the options defined by the user of the recipient device.

29. The machine-readable medium of claim 21, wherein generating the notification comprises generating code specific to a device type of the recipient device, the code for causing the recipient device to present the notification to the user.

30. The machine-readable medium of claim 21, further comprising in response to the user of the recipient device selecting an option from the plurality of options to accept the communication, connecting the initiating device with the recipient device.
